(19) United States
(12) Patent Application Publication
(10) Pub. No.: US 2005/0195604 A1
(43) Pub. Date: Sep. 8, 2005

(54) Low cost fiber illuminator

(76) Inventors: Robert J. Saccomanno, Montville, NJ (US); Ivan B. Steiner, Ridgewood, NJ (US)

Correspondence Address: Honeywell International, Inc., Law Department AB2, PO Box 2245, Morristown, NJ, 07962-2245, US

(21) Appl. No.: 10/793,276

(22) Filed: Mar. 5, 2004

(51) Int. Cl. F21V 7/04; G11B 7/00; G11B 7/135; F21V 1/00; F21V 29/00; G01N 21/00; G02B 6/00; G09F 13/00; G02B 6/04

(52) U.S. Cl. 362/268; 362/294

(57) ABSTRACT

Illumination systems and methods for illuminating one or more remote locations and/or objects from a single light source are disclosed. The illumination systems include a light source that emits light, a radial collimator to partially collimate light, and a plurality of morphing elements to couple the partially collimated light into optical fibers.

### DESCRIPTION OF THE INVENTION

1. Technical Field

The invention generally relates to light guides and, more particularly, to fiber illuminators that distribute light from a light source to a remote location.

2. Background

Distributed or central lighting systems use one or more light sources to illuminate multiple locations remote from a light source. These illumination systems typically include optical fibers, rods, or tubes to transmit light from the light source to the remote locations. One example is a fiber illuminator that uses optical fibers to guide light from a single light source to backlight multiple gauges in a vehicle's instrument panel. Other examples where fiber illuminators can be used include applications in which direct lighting can be dangerous or difficult to maintain.

Besides allowing a single light source to illuminate multiple remote spaced apart locations, fiber illuminators can also, for example, prevent heat damage to thermally sensitive equipment or objects. Because the light source is remote in fiber illuminators, heat and other damaging radiation generated by the light source can be shielded from the thermally sensitive equipment or object. The heat can also be directed away from the light source in such a manner that avoids exposing the thermally sensitive equipment or object to unwanted heat. Thus, for example, objects in a display case can be illuminated without exposure to potentially damaging heat and radiation from direct lighting.

Generally, fiber illuminators couple light from the light source into the fibers using multiple lenses and reflectors. The optical fibers then transmit the light to the remote locations. For example, U.S. Pat. No. 5,892,867 discloses multiple lenses constructed into a spherical structure. The lenses constructed into the spherical structure focus the light from the light source onto multiple focal points. Additional condenser lenses must be positioned at each of the focal points to further focus the light onto the optical fibers. Problems arise, however, due to the complexity and cost of constructing the spherical lens structure and the alignment of the multiple condenser lenses to each of the focal points.

Thus, there is a need to overcome these and other problems of the prior art and to provide a fiber illuminator and a method for its use to illuminate multiple locations remote from the light source.

### SUMMARY OF THE INVENTION

In accordance with an embodiment of the invention, there is provided an illumination system comprising a light source and a radial collimator surrounding the light source. The radial collimator has an inner surface separated from the light source by a thermal barrier region. The illumination system further comprises a morphing element having a light input end adjacent to the radial collimator and a light output end to couple light to an optical fiber.

In accordance with another embodiment of the invention, there is provided an illumination system comprising a light source, a tube surrounding the light source, and a plurality of assemblies disposed around the tube, wherein each of the plurality of assemblies comprises at least one prism and at least one lens. The illumination system further comprises a thermal break disposed between the light source and an inner surface of the tube. The illumination systems also comprises a morphing element having a light input end adjacent to the radial collimator and a light output end to couple light to an optical fiber.

In accordance with another embodiment of the invention, there is provided a fiber illuminator comprising a light source aligned along an axis and a barrel-shaped lens surrounding the light source and aligned along the axis. The barrel shaped lens comprises a cylindrical inner surface and a convex outer surface. The fiber illuminator further comprises a thermal break disposed between the light source and the cylindrical inner surface of the barrel-shaped lens and a plurality of morphing elements. The morphing elements comprise a light input end having a cylindrical shape disposed adjacent to the outer surface of the barrel-shaped lens, and a light output end to couple light to an optical fiber.

In accordance with another embodiment of the invention, there is provided a lighting system comprising a light source, an object remote from the light source, and a light guide. The light guide comprises a radial collimator that partially collimates light from the light source, a plurality of morphing elements adjacent to the radial collimator to collect the partially collimated light from the radial collimator, and an optical fiber coupled to each of the plurality of morphing elements to carry the light collected by the morphing elements to the object.

Yet still further in accordance with another embodiment of the invention, there is provided a method for propagating light to locations remote from a light source comprising providing the light source and partially collimating the light emitted by the light source using a radial collimator surrounding the light source. The partially collimated light projected by the radial collimator is collected with a morphing element comprising a light input end. The light collected by the morphing element is coupled to an optical fiber and transmitted by the optical fibers to the locations remote from the light source.

### BRIEF DESCRIPTION OF THE DRAWINGS

The accompanying drawings, which are incorporated in and constitute a part of this specification, illustrate embodiments of the invention and, together with the description, serve to explain the objects, advantages, and principles of the invention.

In the drawings:

FIG. 1A depicts a top down view of an illumination system in accordance with an exemplary embodiment of the invention.

FIG. 1B depicts a cross sectional view of an illumination system in accordance with an exemplary embodiment of the invention.

FIG. 2A depicts a morphing element including a plano-convex lens in accordance with an exemplary embodiment of the invention.

FIG. 2B depicts a morphing element having a convex end surface in accordance with an exemplary embodiment of the invention.

FIG. 3 depicts a top down view of a fiber illuminator including a plurality of morphing elements in accordance with an exemplary embodiment of the invention.

FIG. 4A depicts a top down view of a fiber illuminator including a plurality of morphing elements arranged in two tiers in accordance with an exemplary embodiment of the invention.

FIG. 4B depicts a cross section of a fiber illuminator including a plurality of radially arranged morphing elements in accordance with an exemplary embodiment of the invention.

FIG. 5 depicts a cross section of a radial collimator in accordance with an exemplary embodiment of the invention.

FIG. 6 depicts a cross section of another radial collimator in accordance with an exemplary embodiment of the invention.

FIG. 7 depicts a cross sectional view of an illumination system in accordance with an exemplary embodiment of the invention.

FIG. 8 depicts a cross sectional view of another illumination system in accordance with an exemplary embodiment of the invention.

FIG. 9 depicts a lighting system in accordance with an exemplary embodiment of the invention.

### DETAILED DESCRIPTION

In the following description, reference is made to the accompanying drawings that form a part thereof, and in which is shown by way of illustration specific exemplary embodiments in which the invention may be practiced. These embodiments are described in sufficient detail to enable those skilled in the art to practice the invention and it is to be understood that other embodiments may be utilized and that changes may be made without departing from the scope of the present invention. The following description is, therefore, not to be taken in a limited sense.

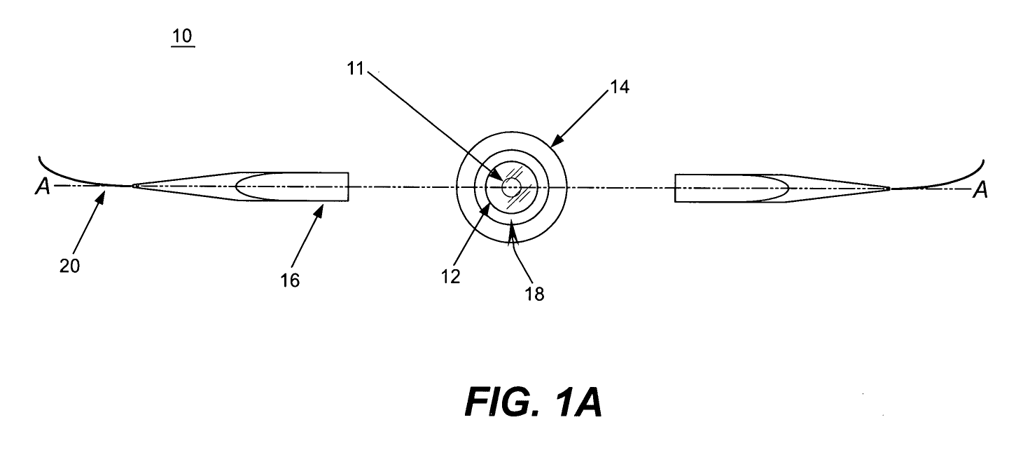

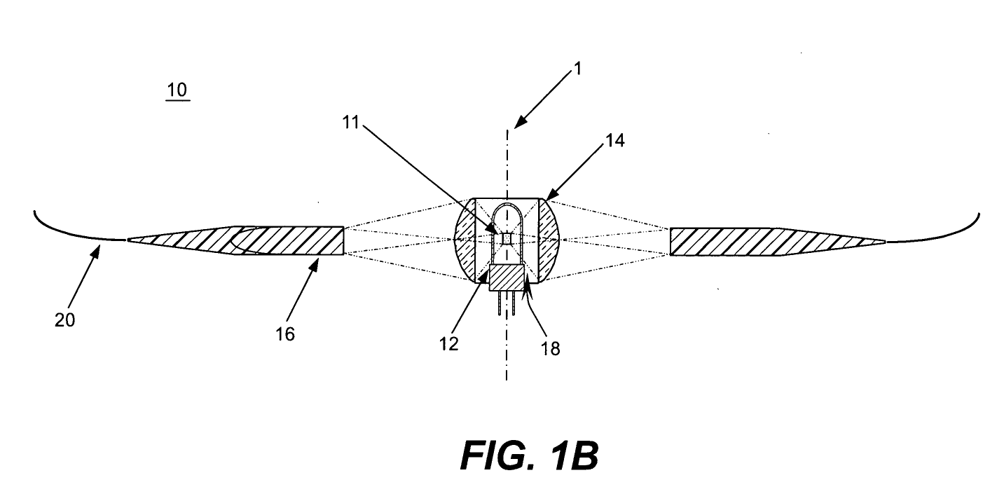

FIGS. 1-9 disclose apparatus and methods for illuminating one or more remote locations using a single light source. Various embodiments include a radial collimator to radially collimate light from the light source and a plurality of morphing elements to couple the radially collimated light to optical fibers. As used herein, “radially collimated” means partially collimated in radial planes containing a centerline axis of a light source. A centerline axis 1 of a light source 12 is shown in FIG. 1.

FIGS. 1A and 1B depict an exemplary illumination system. FIG. 1A shows a top down view of illumination system 10 including a light source 12 and a radial collimator 14. FIG. 1B shows a cross section of illumination system 10 along line A-A of FIG. 1A. Light source 12 can be any appropriate light source. For example, light source 12 can be an arc lamp, such as a ceramic metal halide lamp. Depending on a number of factors, including the locations or objects to be illuminated, the arc lamp can be, for example, a T-6 lamp having an appropriate wattage, such as, 39 W, 70 W, or 150 W and marketed, for example, as the MasterColor series of lamps from Philips Lighting. Light source 12 can also be any point-like emitting surface, such as, for example, a fluorescent particle irradiated by ultraviolet light injected into one or more fibers, as taught by U.S. Pat. No. 6,594,009. In such an embodiment, thermal break 18 isolates the particles from being influenced by external sources of heat. In an exemplary embodiment, light source 12 and radial collimator 14 can be aligned along a centerline axis 1.

In various embodiments, radial collimator 14 surrounds a luminous portion 11 of light source 12. Luminous portion 11 can be, for example, the luminous cylindrical element of a ceramic metal halide lamp. As used herein, the term “radial collimator” means a lens or assembly of optical elements having an overall ring-shape that partially collimates light in radial planes that pass through light source 12 and contain its axis. FIGS. 1A and 1B depict a radial collimator comprising a single anamorphic lens surrounding light source 12. Other appropriate lenses or systems of lenses can also be used by those familiar with the art of optical design not only for the anamorphic lens, but also for other lenses disclosed by this invention. Similarly, one familiar with the art of optical design can replace any of the optical elements disclosed by this invention, such as prisms or lenses with more complex functionally equivalent or functionally superior optical elements, or systems of optical elements known in the art.

Illumination system 10 further includes a thermal break 18, morphing elements 16, and optical fibers 20. Thermal break 18 can be positioned between light source 12 and an inner surface of radial collimator 14. In various embodiments, thermal break 18 permits hot air generated by light source 12 to escape. Thermal break can be, for example, an air gap with static or flowing air. Flowing air can be provided by, for example, the chimney effect of natural convection, a fan, or other cooling system (not shown). Morphing elements 16 can be positioned adjacent to and spaced apart from radial collimator 14. As used herein, “morphing element” means an optical element having an input end to collect radially collimated light and an output end to couple the collected light to an optical fiber. In various embodiments, the cross sectional diameter of the input end has a larger cross sectional diameter than the output end. This can concentrate the propagated light into a reduced cross section to match that of the fiber and preserve etendue along the path of propagation. In this manner, coupling efficiency can be maximized.

Referring to FIG. 1B, radial collimator 14 captures light from luminous portion 11 of light source 12 and partially collimates that light towards the input ends of morphing elements 16. In an embodiment, the size of the input end can exceed the size of luminous portion 11 in order for radial collimator 14 to partially collimate the light it captures from luminous portion 11. As used herein, “partially collimate” means having a smaller numerical aperture on the light output side of radial collimator 14 than the numerical aperture on the light input side of radial collimator 14. In this manner, with proper design, the amount of light captured by radial collimator 14 from luminous portion 11 can be increased without causing any failure of total internal reflection for the light propagating through morphing elements 16. Accordingly, morphing elements 16 collect the light partially collimated by radial collimator 14 and couple that light into optical fibers 20. Optical fibers 20 can be physically coupled to morphing elements 16 by, for example, an index matching fluid, or by other coupling alignment methods known to one of skill in the art. Optical fibers 20 then transmit the light to a location or locations remote from the light source.

In operation, light source 12 generates light and heat. In various embodiments, thermal break 18 convects the heat in an axial direction away from light source 12. Radial collimator 14 can be positioned without critical alignment to partially collimate the light in a continuous ring in a plane orthogonal to centerline axis 1 of light source 12. The partial collimation of light is depicted in FIG. 1B by phantom lines. Morphing elements 16 can be positioned without critical alignment around radial collimator 14 to collect light partially collimated by radial collimator 14 and to couple that light into optical fibers 20. Optical fibers 20 transmit the light to the one or more remote locations. For example, optical fibers 20 can transmit the light to provide backlighting for flat panel displays, architectural lighting, light in dangerous or hazardous environments, or lighting of sensitive objects, such as objects in museums.

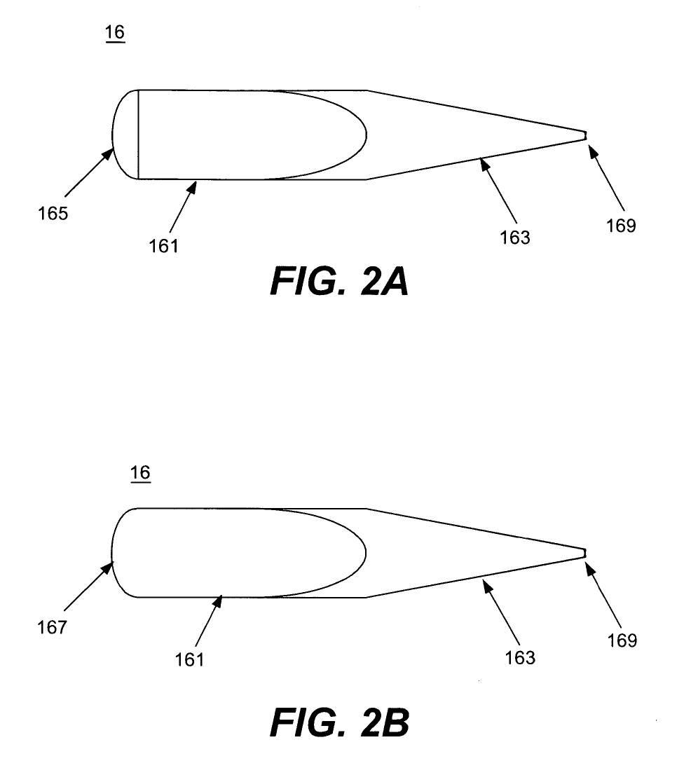

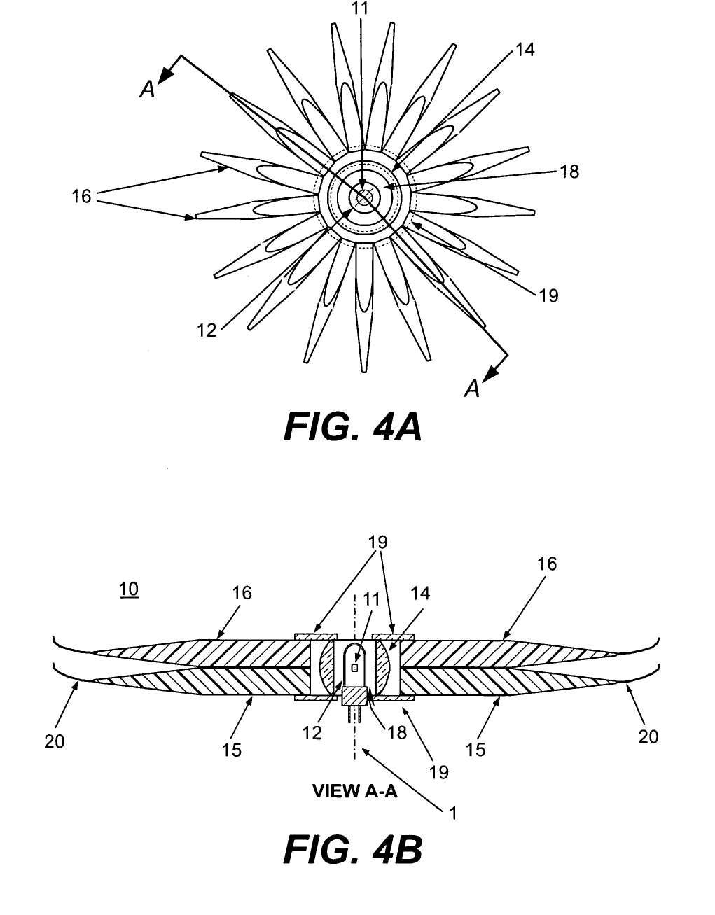

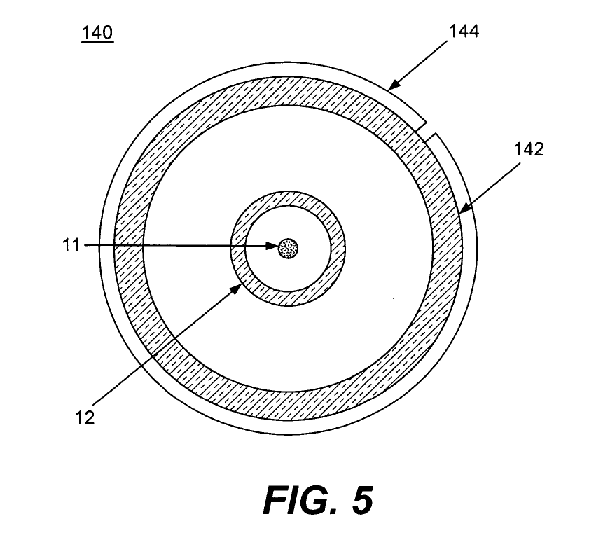

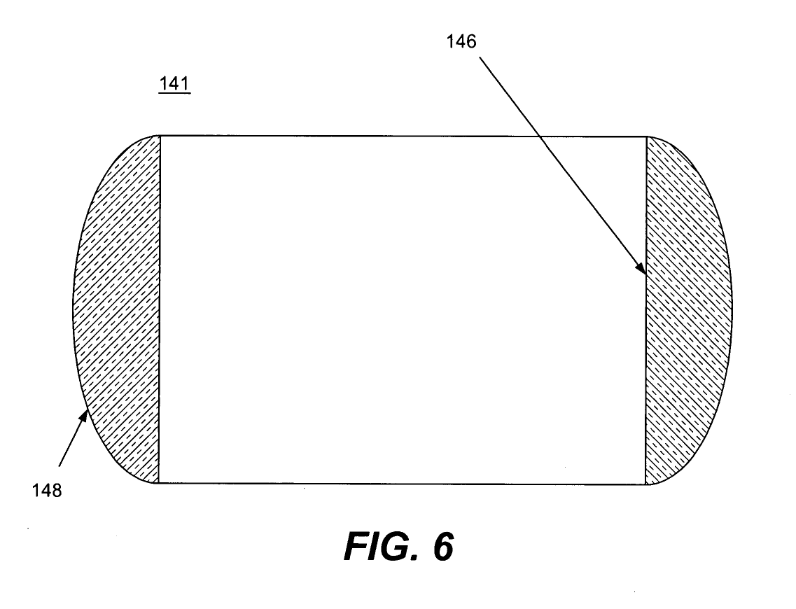

As shown in FIGS. 2A and 2B, morphing elements 16 comprise at least two sections, a first section 161 and a second section 163. First section 161 can be positioned with an input end adjacent to the radial collimator. In FIG. 2A, a plano-convex lens 165 can be positioned at the input end of first section 161. The plano-convex lens can be, for example, a cylindrical lens or cylindrical Fresnel lens. Similarly in FIG. 2B, a convex surface 167 can be applied to the input end of first section 161. The convex surface can be, for example a cylindrical surface or cylindrical Fresnel surface. The convex surfaces of lens 165 or end 167 can be located adjacent to the radial collimator 14 shown in FIGS. 4A and 4B. One of skill in the art understands that the optical design of these ends and surfaces, in combination with that of radial collimator 14, described in more detail with respect to FIGS. 4 and 5, can improve the collimation of the light projected into first sections 161 of morphing elements 16 shown in FIGS. 2A and 2B. Accordingly, it may be possible to increase the numerical aperture of radial lens 14, for example as shown in FIG. 4B in planes containing the axis of light source 12. In this manner, the light-capturing efficiency of radial lens 14 can be increased. Lens 165 and end surface 167 collimate light intercepted from radial collimator 14 and project that light into first section 161, where it propagates by total internal reflection (TIR).

Second sections 163 in FIGS. 2A and 2B capture light projected into them from sections 161. Second sections 163 comprise a conical shape to couple light into optical fibers (not shown) disposed at a light output end 169 of morphing elements 16. In an embodiment, second sections 163 morph from the square or rectangular cross section of section 161 to a round cross section and then taper, conically, to circular light output ends 169 adjacent to optical fibers (not shown). The cross sectional area of ends 169 can be smaller than the cross sectional area of first section 161. In an embodiment, second sections 163 taper so that ends 169 adjacent to the optical fibers are circular in shape and have diameters approximately the same as that of the optical fiber. Morphing elements 16 can be made by methods known to those skilled in the art such as, for example, injection molding a plastic material.

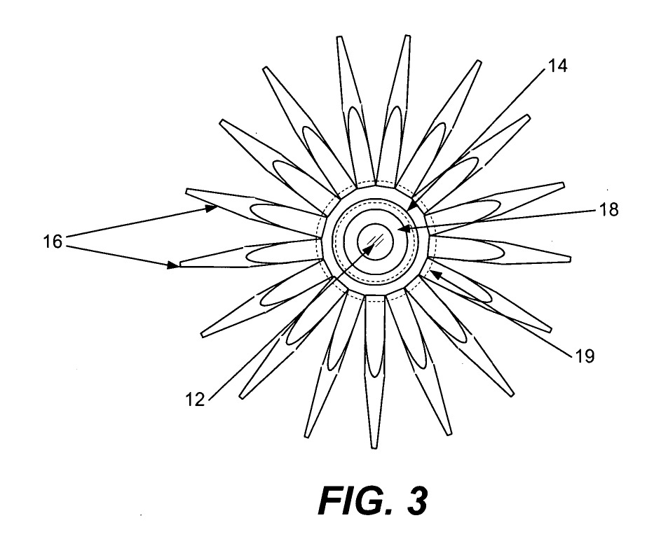

FIG. 3 shows a top down view of a fiber illuminator comprising a plurality of morphing elements 16, which are arranged in a single tier circularly around radial collimator 14. Radial collimator 14 and the plurality of morphing elements 16 are centered around light source 12. Radial collimator 14 can be a barrel-shaped or toroidal lens that surrounds light source 12. Thermal break 18 resides between radial collimator 14 and light source 12. In various embodiments, the number of morphing elements can depend on the cross sectional size and shape of the first section of the morphing elements and on the distance from the morphing elements to the center of radial collimator 14.

In an exemplary embodiment, a plurality of morphing elements can be disposed circularly around the radial collimator and stacked in one or more tiers. FIG. 4A shows a top down view of morphing elements 15 and 16 arranged circularly around radial collimator 14. Morphing elements 16 comprise the upper tier and morphing elements 15 comprise the lower tier. Because morphing elements 15 are below morphing elements 16, morphing elements 15 are not shown in the top down view of FIG. 4A. FIG. 4B shows a cross section view of A-A of FIG. 4A.

Referring again to FIGS. 2A and 2B, the cross sectional shape of sections 161 can be polygonal, such as, for example hexagonal, triangular, square, or rectangular. This eliminates or minimizes gaps between adjacent morphing elements and between multiple tiers of morphing elements. Eliminating gaps improves light propagation efficiency by preventing light leakage through gaps. Morphing elements 15 and 16 can be stacked contiguously and without gaps if their axes remain parallel and their input port apertures are normal to their axes. However, the axis of a stacked element adjacent to one on a different tier and having an axis that passes through the center of the luminous region of light source 12 would be shifted away from that center. This would be acceptable for small shifts. For example, the square or rectangular aperture of a morphing element in FIGS. 4A and 4B can be divided into a plurality of smaller polygons bounded by the edges of that morphing element aperture. These polygons could have the same shapes and sizes (right triangles, for example), or their sizes and shapes could vary. Each polygon aperture can then be the input port of a morphing element with a uniform polygon-shaped cross section that morphs into a conical section that ends in a circular output port. This comprises morphing elements that stack contiguously without gaps and have parallel axes with small shifts from the center of the luminous region of light source 12. For example, one of skill in the art understands that mesh-generating software, typically used in finite element analysis, can be used to identify the shape and size of the elements to construct such as collimator array. Morphing elements 15 in the lower tier can also be off-set from morphing elements 16 in the upper tier. In other words, a morphing element in the lower tier does not have to be directly below a morphing element in the upper tier. Other embodiments comprising multiple tiers can be configured in a similar manner.

As depicted in FIGS. 3, 4A, and 4B, planar mirrors 19 can be used to bridge the air gaps between the top and bottom of radial collimator 14 and morphing elements 16 and 15. The top-down view of FIG. 3 shows mirrors 19, depicted by dotted lines, positioned below radial collimator 14 and morphing element 16 and having a circular annular shape. Similarly, FIG. 4A shows mirrors 19, depicted by dotted lines, positioned below radial collimator 14 and morphing elements 15 and 16, and having a circular annular shape. For the sake of clarity in FIGS. 3 and 4A, the annular planar mirrors positioned above radial collimator 14 in FIG. 4B are not shown. Functionally, the planar mirrors reflect light, which would otherwise leak from the air gap, into the morphing element input ports. As is evident from FIG. 4B, this can improve the light collection efficiency of morphing elements 15 and 16.

FIG. 5 depicts an embodiment of a radial collimator 140 centered around luminous portion 11 of light source 12. Radial collimator 140 comprises a tube 142 and a fresnel lens 144 around tube 142. Tube 142 can be, for example, a cylindrical glass tube. Fresnel lens 144 can be sufficiently thin and flexible to allow wrapping around tube 142. Thin, flexible Fresnel lenses are made, for example, by Fresnel Technologies, Inc. of Fort Worth, Tex. Fresnel lens 144 can also be softened to permit wrapping by heating. In an embodiment, fresnel lens 144 is a cylindrical type of fresnel lens. When wrapped around cylindrical glass tube 142, grooves of Fresnel lens 144 can be oriented circumferentially around tube 144 and in planes normal to the tube axis.

Referring to FIG. 6, another embodiment of the radial collimator that includes only a barrel-shaped lens is shown. As used herein, the term “barrel-shaped lens” means a toroidal lens having a convex outer surface. Radial collimator 141 comprises a cylindrical inner surface 146 and a convex outer surface 148. In an exemplary embodiment, the shape of convex outer surface 148 in cross sectional planes containing the toroid axis of rotational symmetry can be circular, or it can have a non-circular shape. Radial collimator 141 can be, for example, borosilicate glass tubing turned on a lathe to form anamorphic outer surface 148.

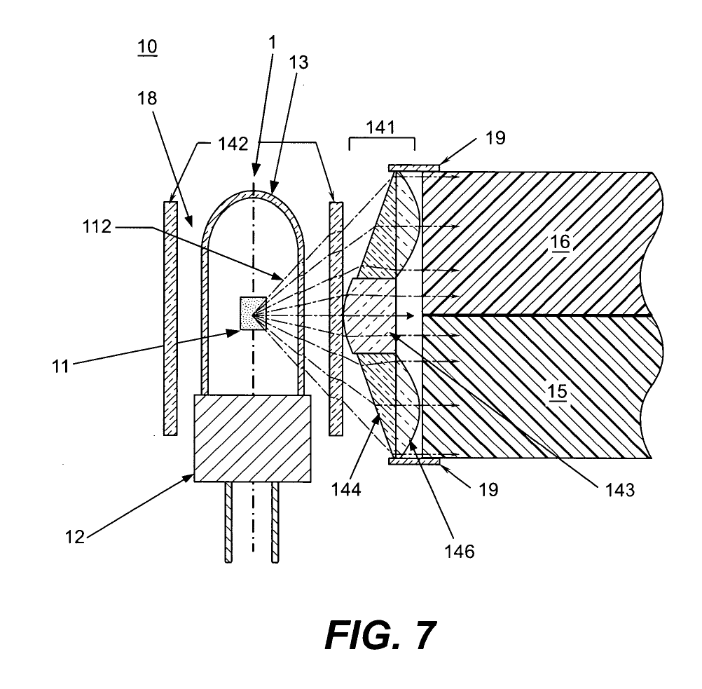

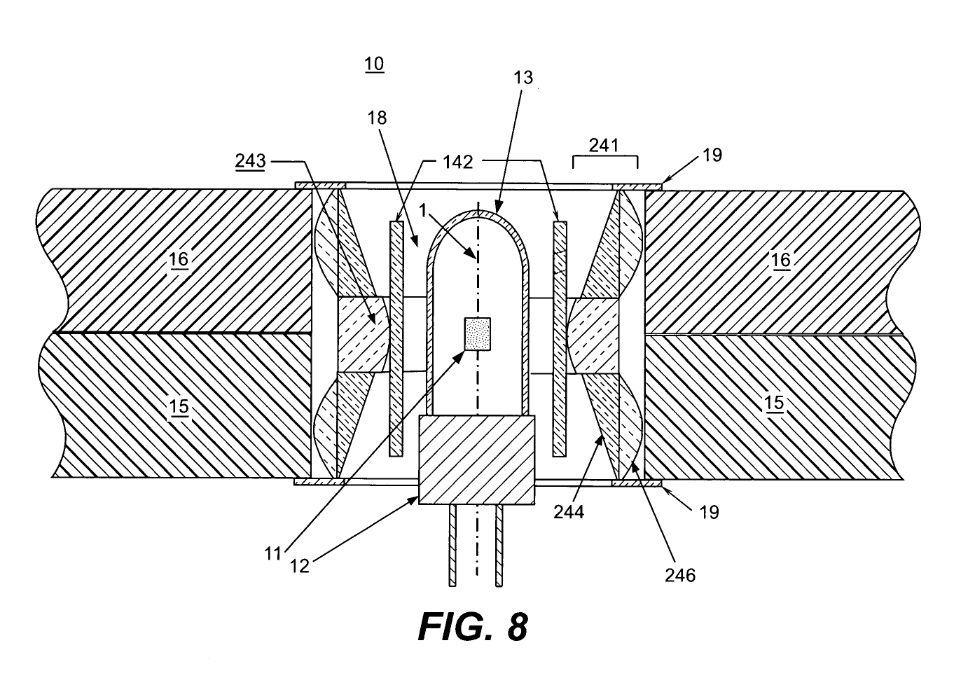

In another exemplary embodiment, a fiber illuminator uses a plurality of assemblies 141 to radially collimate light. FIG. 7 depicts a cross section of a fiber illuminator 10. Fiber illuminator 10 comprises a light source 12 including a glass envelope 13 that encloses an arc element 11. Light source 12 is centered on a centerline axis 1. A tube 142, such as a glass or polymer cylinder surrounds light source 12 and is also centered on axis 1. Thermal barrier 18, such as an air gap can be disposed between glass envelope 13 and tube 142 to permit heat dissipation.

In various embodiments, multiple assemblies 141 can be arranged around and centered on centerline 1 of light source 12. A single assembly 141 is shown in FIG. 7. It comprises a plurality of lenses and prisms to radially collimate light that passes through tube 142. Light rays from luminous portion 11 of light source 12, which are intercepted by assembly 141, are nearly collimated when projected on a plane normal to centerline 1 of light source 12. However, when projected on the plane containing centerline 1 of light source 12 and the center of assembly 141 (which is in the plane of the view of FIG. 7), the rays 112 propagating from luminous portion 11 to assembly 141 are not collimated. Accordingly, FIG. 7 illustrates how rays 112 in this projected view can become collimated upon passage through the optical elements 143, 144, and 146.

In various embodiments, light may propagate at large angles from an axis normal to centerline 1 in FIG. 7 This is illustrated by light rays 112 in FIG. 7, which is a cross sectional plane containing centerline 1 and the center of assembly 141. Accordingly, that light can pass through tube 142 and be radially collimated by a combination of prisms 144 and cylindrical lenses 143 and 146. In an exemplary embodiment, prisms 144 are symmetrically positioned about cylindrical lens 143. Light radially collimated by prisms 144 and cylindrical lenses 143 and 146 pass into morphing elements positioned as a first tier 15 and a second tier 16. Assembly 141 can farther include planar mirrors 19 positioned to bridge gaps between cylindrical lenses 146 and morphing elements 15 and 16. Because the curvature of cylindrical lenses 146 cause air gaps to exist between cylindrical lenses 146 and morphing elements 15 and 16, some of the light projected by cylindrical lenses 146 can leak out from the air gap and, thereby, avoid capture by morphing elements 15 and 16. As shown in FIG. 7, planar mirrors 19 positioned to bridge the gaps between cylindrical lens 146 and morphing elements 15 and 16 can reduce this loss of light. In an embodiment, planar mirrors 19 can be configured as annular rings with symmetry about the light source 12 axis. Although FIG. 7 depicts particular prisms and lenses, one of skill in the art understands that other lenses and prisms may be used. For example, the curvature of lenses 143 and 146 can be noncircular in planes containing the light source 12 axis. Additionally, the sides of prisms 144 that face the lamp can have curvature in planes containing the light source 12 axis to improve collimation.

In another embodiment, a fiber illuminator 10, shown in cross section in FIG. 8, comprises prisms 244 and lenses 243 and 246 that are each monolithic ring elements with circular symmetry about the axis of light source 12. Light source 12 comprises a glass envelope 13 that encloses an arc element 11. Tube 142, such as a glass cylinder, surrounds light source 12 and is also centered on an axis 1 of light source 12. Thermal barrier 18, such as an air gap, can be disposed between glass envelope 13 and tube 142 to permit heat dissipation. Ring element lenses 243 and 246 can be toroidal. The inner surface of ring element prisms 244 facing light source 12 may be conical and an outer surface of ring element prisms 244 facing lens 246 may be cylindrical. In an embodiment where those surfaces contact each other, the surface of lens 246 matches the adjacent surface of prisms 244. In this way, assembly 241 is a radial collimator that comprises ring elements having circular symmetry about lamp 12. Assembly 241, comprising ring elements, eliminates side seams that exist between multiple adjacent assemblies such as, for example, assemblies 141 of FIG. 7. In an embodiment, annular mirrors 19 with symmetry about the axis of light source 12 can be used to minimize light lost from gaps between ring element lenses 246 and morphing elements 15 and 16. One of skill in the art will recognize that assembly 141 can also be configured to be monolithic and that additional configurations of lenses and/or prisms may be used to collimate light in radial directions.

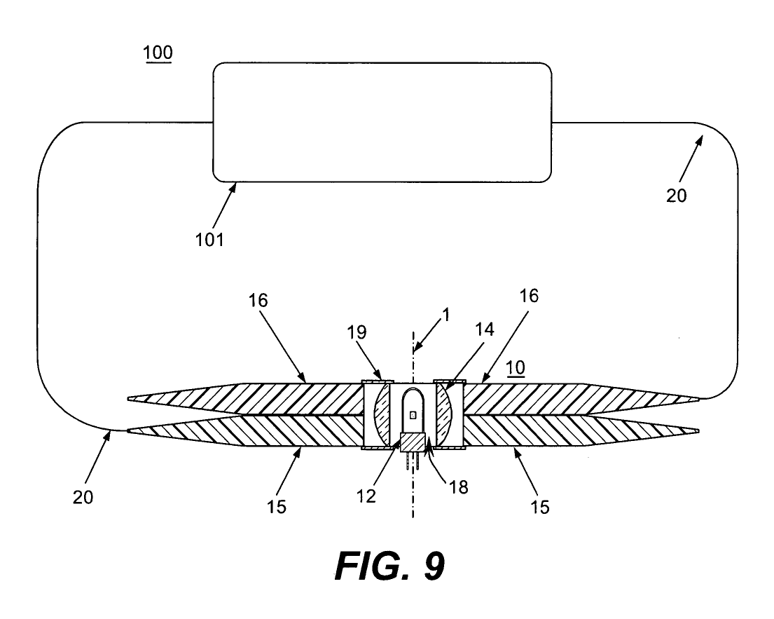

In another exemplary embodiment, a lighting system for illuminating a remote object or providing illumination to a remote location is disclosed. FIG. 9 depicts an exemplary lighting system 100 including light guide 10. Light guide 10 comprises a light source 12 and a radial collimator 14. Light source 12 can be an arc lamp, such as, for example, a T-6 lamp having an appropriate wattage. Radial collimator 14 can be a barrel-shaped glass lens. In an exemplary embodiment, the outer surface of radial collimator 14 is toroidal. Radial collimator 14 surrounds light source 12 and has an inner surface separated from light source 12 by a thermal break 18. In an exemplary embodiment, light source 12 and radial collimator 14 can be centered on a centerline 1.

In various embodiments, light guide 10 further includes morphing elements 15 and 16, optical fibers 20, and planar mirrors 19 that bridge the gap between radial lens 14 and morphing elements 15 and 16. Morphing elements 15 and 16 surround radial collimator 14 in the manner shown in FIG. 3. Alternative embodiments of one or more tiers can be configured. In an exemplary embodiment, morphing elements 15 and 16 comprise a square, rectangular, hexagonal, or triangular first section that morphs into a conical second section. The first section comprises a light input end having a convex surface. The conical second section terminates at a light output end having a cross sectional diameter approximately the same as the cross sectional diameter of optical fibers 20. Although FIG. 9 depicts only two optical fibers coupled to two morphing elements, one of skill in the art will understand that optical fibers can be coupled to each of the morphing elements and that light coupled into each of the optical fibers can additionally be split into multiple fibers. Optical fibers 20 can be physically coupled to morphing elements 15 and 16 by, for example, an index matching fluid, or by other methods of alignment and coupling known to one of skill in the art. Also, all the optical fibers need not provide illumination to the same remote location 101. Alternative embodiments can route one or more optical fibers to each location of a plurality of remote locations. Other embodiments can include different sized morphing elements to feed different sized fibers.

In operation, according to various embodiments, light source 12 emits light. Thermal break 18 dissipates the heat away from light source 12. Radial collimator 14 partially collimates the light into a ring plane orthogonal to a centerline 1 of light source 12. Morphing elements 15 and 16 collect light partially collimated by radial collimator 14 and couple that light into optical fibers 20. Optical fibers 20 transmit the light to illuminate portions of object 101 that are remote from light source 12.

In various embodiments, optical fibers 20 transmit the light to object 101 that is remote from light source 12. Object 101 can be a visual information system, such as, for example, an instrument panel requiring backlighting. As used herein, “visual information system” means any display, gauge, device, or system that shows information such as, for example, instrument panels and computer displays. Object 101 can also be, for example, a display case for items sensitive to heat or radiation, architecture requiring multiple lighting locations from a single light source, dangerous or hazardous locations requiring lighting from a remote light source, or any object that is lit from a remote light source.

It will be apparent to those skilled in the art that the illuminations systems and methods described in the present invention can be used to illuminate multiple locations remote from a single light source. It will be also apparent to those skilled in the art that various modifications and variations can be made in the disclosed process without departing from the scope or spirit of the invention. Other embodiments of the invention will be apparent to those skilled in the art from consideration of the specification and practice of the invention disclosed herein. It is intended that the specification and examples be considered exemplary only, with a true scope of the invention being indicated by the following claims.

1. An illumination system comprising:
a light source;
a radial collimator surrounding a portion of the light source, the radial collimator having an inner surface separated from the light source by a thermal barrier region; and
a morphing element comprising a light input end adjacent to the radial collimator and a light output end to couple light to an optical fiber.

2. The illumination system of claim 1, wherein the morphing element further comprises a first portion having a polygonal cross section and a second portion having a conical cross section.

3. The illumination system of claim 1, wherein the morphing element further comprises a cylindrical Fresnel lens adjacent to the light input end.

4. The illumination system of claim 1, wherein the light input end of the morphing element has a convex shape.

5. The illumination system of claim 1, further comprising a plurality of morphing elements surrounding the radial collimator and arranged in a plurality of tiers.

6. The illumination system of claim 1, further comprising a plurality of morphing elements surrounding the radial collimator and arranged in a single tier.

7. The illumination system of claim 1, wherein the radial collimator comprises a cylindrical tube and a Fresnel lens around the cylindrical tube.

8. The illumination system of claim 1, wherein the radial collimator comprises a ring-shaped lens having a cylindrical inner surface and a convex outer surface.

9. The illumination system of claim 8, wherein the-radial collimator is toroidal.

10. An illumination system comprising:
a light source;
a tube surrounding the light source;
at least one assembly disposed around the tube, wherein each of the at least one assemblies comprises at least one prism and at least one lens configured to radially collimate light emitted from the light source;
a thermal break disposed between the light source and an inner surface of the tube; and
a plurality of morphing elements, each morphing element comprising a light input end adjacent to the radial collimator and a light output end to couple light to an optical fiber.

11. The illumination system of claim 10, wherein the morphing element further comprises:
a first portion adjacent to the light input end, wherein the first portion has a polygonal shape;
a second portion adjacent to the light output end, wherein the second portion has a conical shape; and
wherein the first portion adjoins the second portion.

12. The illumination system of claim 10, wherein the at least one assembly comprises a plurality of assemblies centered around the light source.

13. The illumination system of claim 10, wherein the at least one assembly comprises ring-shaped elements with circular symmetry around the light source.

14. The illumination system of claim 10, further comprising at least one mirror disposed to increase capture of light by the morphing elements.

15. A fiber illuminator comprising:
a light source aligned along an axis;
a barrel-shaped lens surrounding a portion of the light source and aligned along the axis, wherein the barrel shaped lens comprises a cylindrical inner surface and a convex outer surface;
a thermal break disposed between the light source and the inner surface of the barrel-shaped lens; and
a plurality of morphing elements comprising,
a light input end having a convex shape disposed adjacent to the outer surface of the barrel-shaped lens, and
a light output end to couple light to an optical fiber.

16. The fiber illuminator of claim 15, wherein each of the plurality of morphing elements further comprise a first portion having polygonal shape and a second portion having a conical shape.

17. The fiber illuminator of claim 15, wherein the plurality of morphing elements are arranged radially around the axis in at least one tier.

18. The fiber illuminator of claim 15, wherein the convex outer surface is at least one of a convex toroidal surface and an anamorphic aspheric outer surface.

19. The fiber illuminator of claim 15, further comprising at least one mirror to increase collection of light by the morphing elements.

20. A lighting system comprising:
a light source; and
a light guide comprising,
a radial collimator that partially collimates light from the light source, and
a plurality of morphing elements adjacent to the radial collimator to collect the partially collimated light from the radial collimator; and
an optical fiber coupled to each of the plurality of morphing elements to transmit the light collected by the morphing elements away from the light source.

21. The lighting system of claim 20, wherein the morphing element comprises a light input end having a cylindrical Fresnel surface and a light output end to couple to the optical fiber.

22. The lighting system of claim 20, wherein the morphing element comprises a first portion adjacent to the light input end having a rectangular shape and a second portion adjacent to the light output end having a conical shape.

23. The lighting system of claim 20, wherein an object to be illuminated is a visual information system and wherein the light source provides backlighting to the visual information system.

24. The lighting system of claim 20, wherein an object to be illuminated is remote from the light source to protect the object from at least one of heat and infrared radiation emanating from the light source.

25. The lighting system of claim 20 further comprising at least one mirror disposed to increase collection of light by the morphing elements.

26. A method for propagating light to a location remote from a light source comprising:
providing the light source;
partially collimating the light emitted from the light source using a radial collimator surrounding the light source;
collecting the partially collimated light projected from the radial collimator with a morphing element comprising a light input end having a cylindrical Fresnel surface;
coupling the light collected by the morphing element to an optical fiber; and
transmitting the light coupled to the optical fiber to the location remote from the light source.
